(19) United States
(12) Patent Application Publication
(10) Pub. No.: US 2021/0096912 A1
(43) Pub. Date: Apr. 1, 2021

(54) METHOD AND SYSTEM FOR PROCESSING OF COMPUTER SYSTEM PROCESSES IMPLEMENTED BY EXECUTING SEQUENTIAL OR CONCURRENT TASKS

(71) Applicant: Logpickr, Cesson-Sevigne (FR)

(72) Inventor: Fabrice Baranski, Chantepie (FR)

(21) Appl. No.: 17/031,836

(22) Filed: Sep. 24, 2020

(30) Foreign Application Priority Data
Sep. 27, 2019 (FR) 1910731

(51) Int. Cl. G06F 9/48; G06F 9/38; G06F 16/901

(52) U.S. Cl. CPC G06F 9/4887; G06F 9/485; G06F 16/9024; G06F 9/38; G06F 9/4818

(57) ABSTRACT

A method and system for processing computer system processes implemented by executing sequential or concurrent tasks, execution of the processes by the computer system generating computer traces of execution of the tasks, stored in a memory of the computer system. The processing method includes, for at least one execution instance of a process, a computation of a representation model of the executed process, in graph form including nodes and links between the nodes, the links being representative of a temporal succession between tasks executed from computer traces of execution of the process, then determination of concurrent links associated with concurrent tasks executed at least partially in a same predetermined time interval, and then obtaining and displaying a simplified graph representative of a comprehensive model of the process including graphic elements selectable by an operator in order to obtain statistical information on the concurrent links.

### FIELD OF THE INVENTION

The present invention relates to a method and a system for processing of computer system processes implemented by executing sequential or concurrent tasks.

The invention falls within the field of performance analysis and the optimization of processes implemented by computer systems, for example in a business.

### BACKGROUND OF THE INVENTION

One of the aims sought is to identify the bottlenecks in the implemented processes, which involve slowdowns in processing or an overuse of available computing resources and memory resources. This next makes it possible to modify and optimize the implemented processes.

Such an issue arises in various applications, in particular in the processes implemented in a business or a factory, to produce goods or services. Indeed, at this time, businesses use complex computing systems, including company networks, and the implemented processes, including the performance of software tasks, sequentially or substantially in parallel, are also numerous and complex. The need to develop tools in order to analyze the implemented processes automatically has become noticeable.

The field of automatic process analysis implemented by computer systems is referred to as “process mining”.

International standard ISO/CEI 19510 defines a Business Process Model and Notation (BPMN), associated with a business process modeling method in graphic representation form.

One of the problems that has not been addressed is the determination of concurrent tasks of a process, that is to say tasks executed at least in part in a same time interval, and the emphasis of such tasks in a manner that is comprehensible and usable by operators who are not specialists in the field of process mining.

### SUMMARY OF THE DESCRIPTION

To that end, according to one aspect, the invention proposes a method for processing of computer system processes implemented by executing sequential or concurrent tasks, the execution of said processes by the computer system generating computer traces of the execution of the tasks, stored in a memory of the computer system, the processing method being implemented by a computing processor. The method includes the following steps, for each processed process:
for at least one execution instance of said processes,
obtaining, from recorded computer traces, data including, for each executed task, at least a descriptive task label, a beginning of execution date and an end of execution date,
computing, using the data, a representation model of the executed process, in graphic form including nodes and links between the nodes, the links being representative of a temporal succession between executed tasks,
determining concurrent links associated with concurrent tasks executed at least partially in a same predetermined time interval,
and obtaining and displaying a simplified graph representative of a comprehensive model of the process from graphs obtained for execution instances of the process, the simplified graph including graphic elements able to be selected by an operator in order to obtain statistical information on the concurrent links.

Advantageously, the method for processing of computer system processes according to the invention makes it possible to determine the presence of concurrent tasks by computation and proposes a simplified graph display that is easier for an operator to interpret.

The method for processing of computer system processes according to the invention may have one or more of the features below, considered independently or according to all acceptable combinations.

The computation of a representation model of the process in graph form includes, for each execution instance of said process, a first step for sequencing the performed tasks, based on task start dates, ranked in an increasing order.

The computation of a representation model of the process includes generating a complete graph, for each execution instance of said process, including start nodes, end nodes and intermediate nodes representative of executed tasks and associated with descriptive labels of the executed tasks, the nodes being connected by links.

The complete graph further includes connecting nodes, placed between a node associated with a task having several predecessors and its predecessors or between a node associated with a task having several successors and its successors.

The method further includes a computation of a simplified graph for each execution instance of the process.

The method includes, for each execution instance of the process, a computation of a data structure including indications of concurrence between links in said execution instance of the process.

The method includes a computation of statistical information on concurrent links of the process by using the data structures computed for each execution instance of the process.

The statistical information comprises a concurrence ratio for each pair of concurrent links computed as a function of the total number of execution instances of the process.

The selectable graphic elements are the links of the simplified graph.

According to another aspect, the invention relates to a system for processing of computer system processes implemented by executing sequential or concurrent tasks, the execution of the processes by the computer system generating computer traces of the execution of the tasks, stored in a memory of the computer system. The processing system includes a computing processor configured to implement, for each processed process:

for at least one execution instance of said processes,
a module for obtaining, from recorded computer traces, data including, for each executed task, at least a representative task label, a beginning of execution date and an end of execution date,
a module for computing, using the data, a representation model of the executed process, in graphic form including nodes and links between the nodes, the links being representative of a temporal succession between executed tasks,
a module for determining concurrent links associated with concurrent tasks executed at least partially in a same predetermined time interval,
a module for obtaining and displaying a simplified graph representative of a comprehensive model of the process from graphs obtained for execution instances of the process, the simplified graph including graphic elements able to be selected by an operator in order to obtain statistical information on the concurrent links.

According to another aspect, the invention relates to a computer program product, recorded on a non-transitory support, including software instructions which, when they are implemented by a computer, carry out a method for processing processes as briefly described above.

### BRIEF DESCRIPTION OF THE DRAWINGS

Other features and advantages of the invention will emerge from the description thereof provided below, for information and non-limitingly, in reference to the appended figures, in which:

FIG. 1 schematically illustrates a system for processing processes implemented by a computer system according to one embodiment;

FIG. 2 is a block diagram of the main steps of a method for processing processes according to one embodiment;

FIG. 3 shows a table of data extracted from execution traces of a first execution instance of a process in one application scenario;

FIG. 4 shows a complete graph corresponding to the application scenario of FIG. 3;

FIG. 5 shows a simplified graph corresponding to the application scenario of FIG. 3;

FIG. 6 shows a matrix of concurrent links corresponding to the application scenario of FIG. 3;

FIG. 7 shows a table of data extracted from execution traces of a second execution instance of a process;

FIG. 8 shows a simplified graph corresponding to the application scenario of FIG. 7;

FIG. 9 shows a matrix of concurrent links corresponding to the application scenario of FIG. 7;

FIG. 10 shows a comprehensive matrix of concurrent links; and

FIG. 11 shows a displayed simplified graph corresponding to the application scenario of FIGS. 3 and 7.

### DETAILED DESCRIPTION

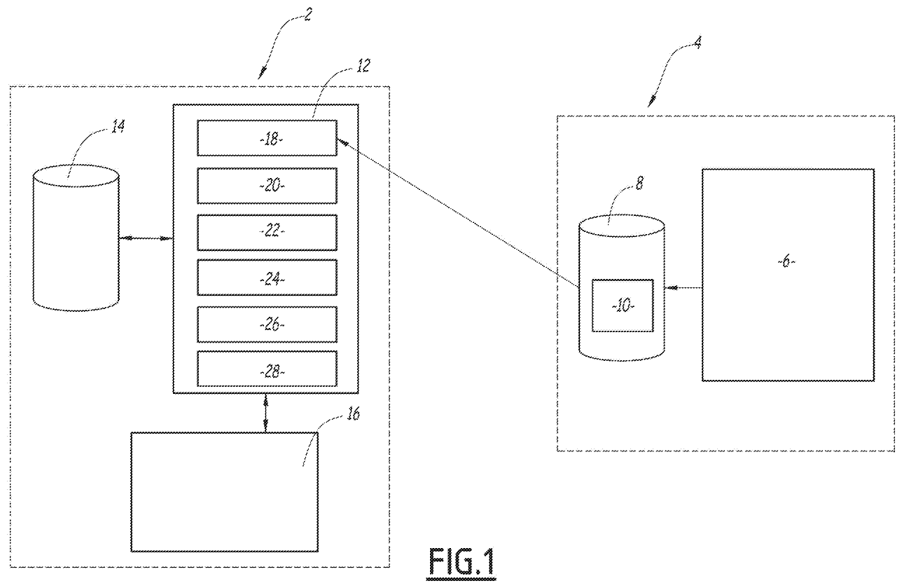

FIG. 1 schematically illustrates a system for the processing of computer system processes 2 according to one embodiment of the invention, which processes one or several processes executed by a computer system 4, which executes sequential or concurrent software tasks 6, execution of the processes by the computer system generating computer traces 10 of execution of the tasks that are stored in a memory 8 of computer system 4.

The executed processes are inherent to computer system 4, or defined by the user in the context of an application to be done.

Each process is executed in several execution instances.

For each instance of a process, sequential or concurrent software tasks 6 are executed, and computer traces 10 of the execution are stored.

Computer system 4 is, for example, a business system, including a plurality of computers connected in a local network.

Execution traces 10 are, for example, stored in files formatted according to the CSV (Comma Separated Values) format, or any other appropriate file format.

Hereinafter, the processing of a process from a plurality of execution instances of this process will be described.

Of course, the invention similarly applies for the processing of any number of different processes.

For a given task, the execution trace includes a unique identifier of the execution of a process, or identifier of an instance of the process, and for each executed task, a start date of the execution, an end date of the execution, and a descriptive label of the task.

The system for processing of processes 2 according to the invention includes a programmable electronic device 12, typically a computer, including one or several computing processors, able to execute computations and computer program code instructions when they are powered on.

The programmable device includes or is connected to an electronic memory unit 14 and to a man-machine interface 16. Man-machine interface 16 is, for example, a touch-sensitive screen, configured to display and receive entries by an operator.

Elements 12, 14, 16 are connected via communication buses.

Programmable device 12 implements modules 18 for obtaining traces of execution of tasks, computing 20 a model representative of a process in graphic form, storing 22 in a database, computing 24 a simplified graph, computing 26 statistics for concurrent links and displaying 28 a simplified graph including selectable graphic objects.

Modules 18, 20, 22, 24, 26, 28 implementing a method for processing of processes according to the invention are, for example, software modules, including executable code instructions. The method for processing of processes according to the invention is then performed by a computer program, which may be stored on a non-transitory computer-readable medium, not shown. The computer-readable medium is, for example, a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card.

In a variant that is not shown, modules 18, 20, 22, 24, 26, 28 are each made in the form of a programmable logic component, such as an FPGA (Field Programmable Gate Array), a GPU (Graphics Processing Unit) or a GPGPU (General-Purpose Processing on Graphics Processing Unit), or in the form of a dedicated integrated circuit, such as an ASIC (Application-Specific Integrated Circuit).

The method for processing of processes according to the invention includes several steps.

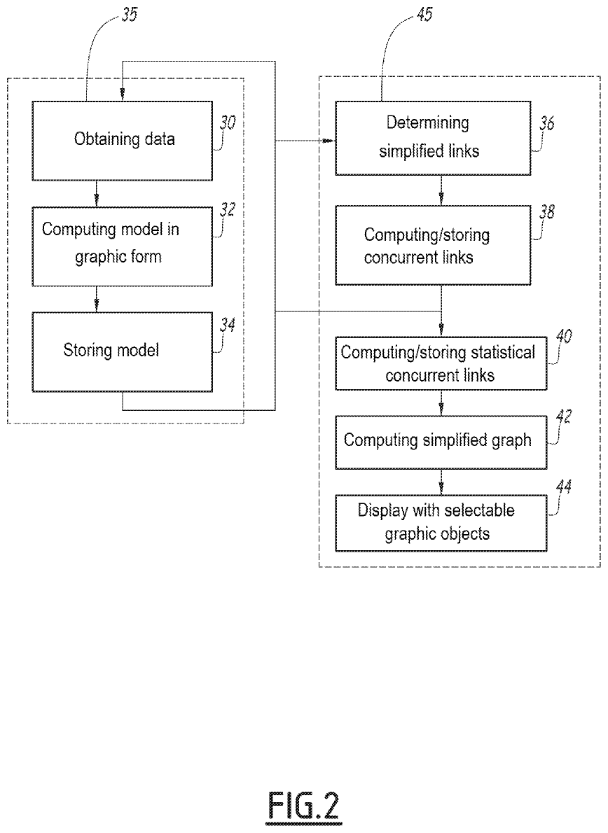

FIG. 2 is a block diagram of the main steps of the method in one embodiment of the invention.

The method includes two phases; a phase 35 for computing a graph representative of a process model from execution instances of the process, and a phase 45 for generating and displaying a simplified graph representative of a model of the process.

The steps of first phase 35 are executed for each execution instance of a process.

First phase 35 includes a first step 30 for obtaining, from computer traces for execution of the process, data including, for each executed task, at least one process execution instance identifier, and for each executed task, an execution start date and an execution end date, and a descriptive task label.

Next, a step 32 for computing a model in graph form, including a detection of the concurrent tasks and of the successive tasks is implemented.

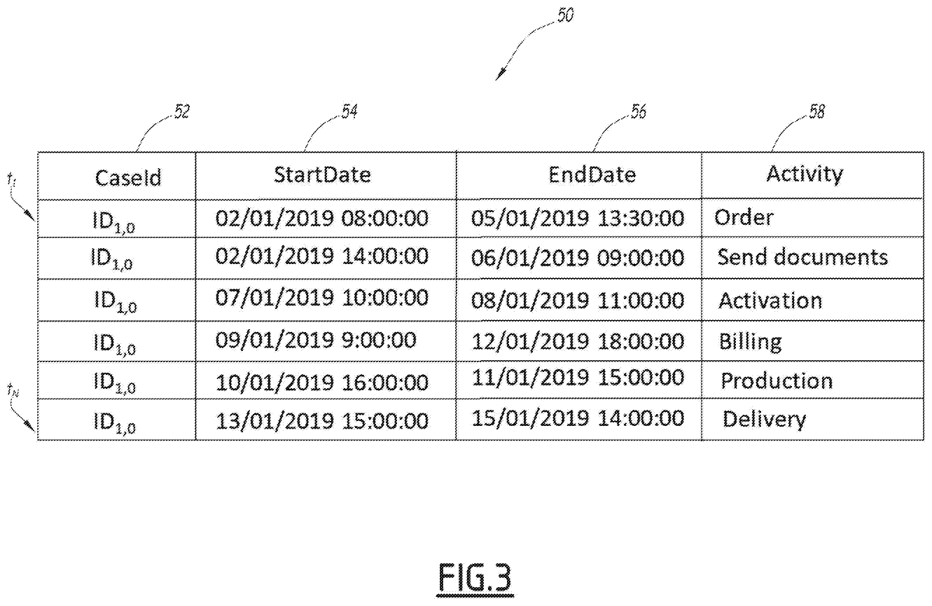

An example for an instance of a processed process is illustrated in reference to FIGS. 3 to 5.

FIG. 3 illustrates, for this example, data recovered from computer traces, in table form 50.

In this example, table 50 includes 4 columns, respectively a column 52 including a process instance identifier (ID_{1,0} in FIG. 3), a column 54 including a start date for execution of a task, a column 56 including an end date for execution of a task, and a column 58 including a descriptive label of the executed task.

In the example of FIG. 3, all of the listed tasks belong to a same process instance.

The rows of the table correspond to traces ti to tN, N being the number of traces.

The dates are, in the example of FIG. 3, expressed in day/month/year and “hour: minutes/seconds” form. Of course, alternative date formats can be used as a variant.

The execution range of a task is the time range between the execution start date and the execution end date.

Two tasks are considered to be concurrent if their respective execution ranges overlap.

In other words, two tasks are concurrent if the start date of one is less than the end date of the other.

In the example of FIG. 3, it is observed that the “order” and “send documents” tasks are concurrent tasks, as are the “billing” and “production” tasks.

Computing step 32 includes sequencing of the tasks in increasing order of task start dates, then increasing order of task end dates, then the implementation of an algorithm making it possible to generate a graph representative of the concurrent tasks and successive tasks, formalized according to the BPMN standard.

The model thus computed is stored during a storing step 34, preferably in an OLAP (Online Analytical Processing) database.

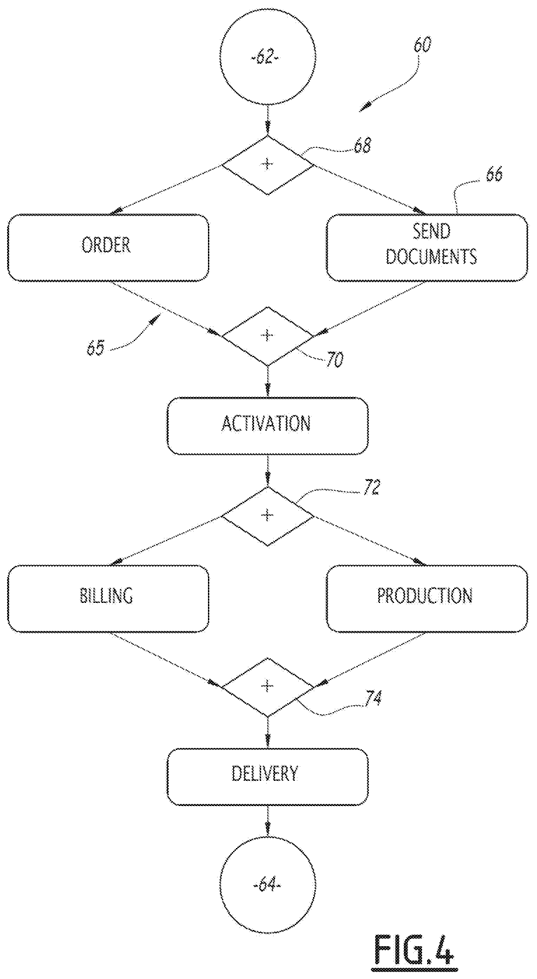

An exemplary graph showing the process instance defined by the exemplary data traces in FIG. 3 is illustrated in FIG. 4.

Graph 60 includes start nodes 62, end nodes 64, intermediate nodes 66 and links 65.

Intermediate nodes 66 are representative of executed tasks, and they are associated with the descriptive labels of the tasks.

Graph 60 also includes connecting nodes 68, 70, 72, 74 that are of a first type, GATEWAY_AND_SPLIT (nodes 68), a second type, GATEWAY_AND_JOIN (nodes 70) according to the BPMN terminology, or of a third type GATEWAY_XOR-SPLIT (node 72).

The connecting nodes of the third type, introduced specifically, are placed between a task having several predecessors and its predecessors, or between a task having several successors and its successors.

The nodes of the graph are connected by oriented links, shown by arrows in FIG. 4. A link between two nodes represents a temporal succession of the execution of associated tasks.

The complete graph modeling the tasks of the computed process is next simplified in phase 45 for simplification and display of the processing method according to the invention, making it possible to display a simplified graph, including graphic elements that are selectable by an operator in order to obtain statistical information on concurrent links.

Concurrent links refer to links of the graph that connect nodes associated with concurrent tasks in at least one execution instance of the process. Concurrence is determined by pairs of links, as explained in more detail hereinafter.

The simplification and display phase 45 includes a step 36 for computing simplified links between nodes corresponding to executed tasks, or to start and end nodes of the graph. One simplified graph per instance of the process may be generated.

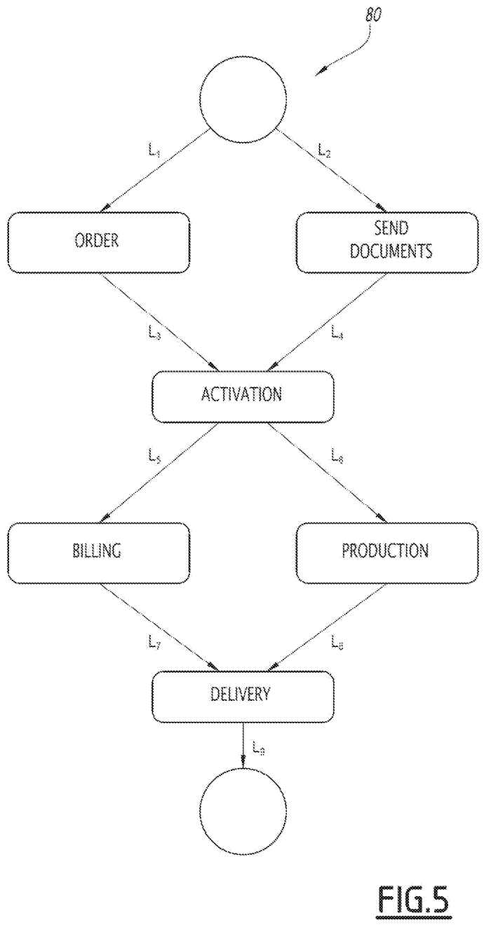

In reference to the process example described above in connection with FIGS. 3 and 4, simplified graph 80 is illustrated in FIG. 5.

In this graph, nine links, denoted L₁ to L₉, are distinguished, some of these links being concurrent links: links L₁ and L₂, links L₃ and L₄, links L₅ and L₆, links L₇ and L₈.

For the concurrent links, for each instance of the process, a data structure including concurrence indications is computed and stored in step 38.

In the illustrated embodiment, the data structure is a matrix. For one instance of a process, the presence or absence of concurrence is indicated in the matrix, by a “one” in case of concurrence, and by a “zero” in case of absence of concurrence.

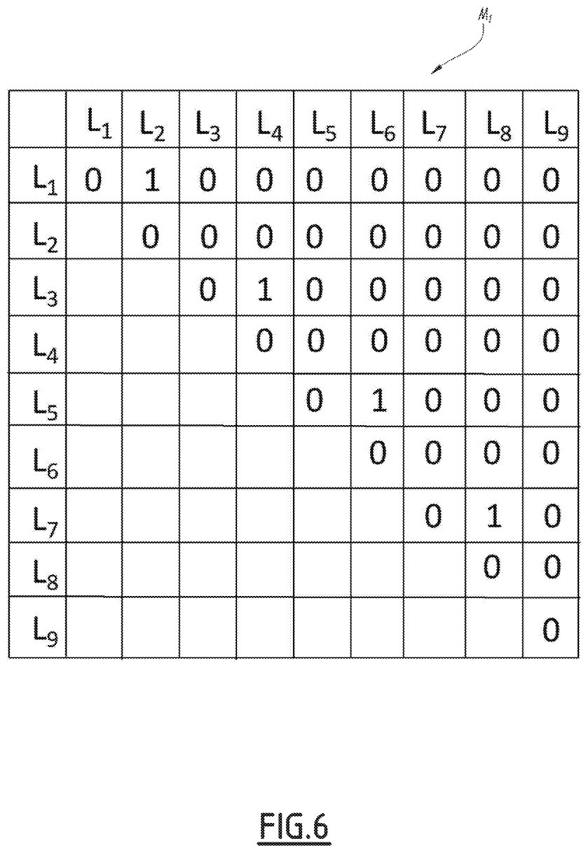

FIG. 6 illustrates a binary matrix M₁ indicating the presence of concurrent links. In this matrix, a “1” indicates that two links are concurrent, and a “0” indicates the absence of concurrence between two links.

In an alternative embodiment, it is considered to indicate, for a process instance, a concurrence ratio based, for example, on the proportion of overlap of the temporal execution ranges of the concurrent tasks corresponding to the link relative to a temporal execution range of the two tasks.

Steps 30 to 38 are repeated for a plurality P of instances of a same process.

For each instance of the process, at the end of step 38, a simplified graph is obtained.

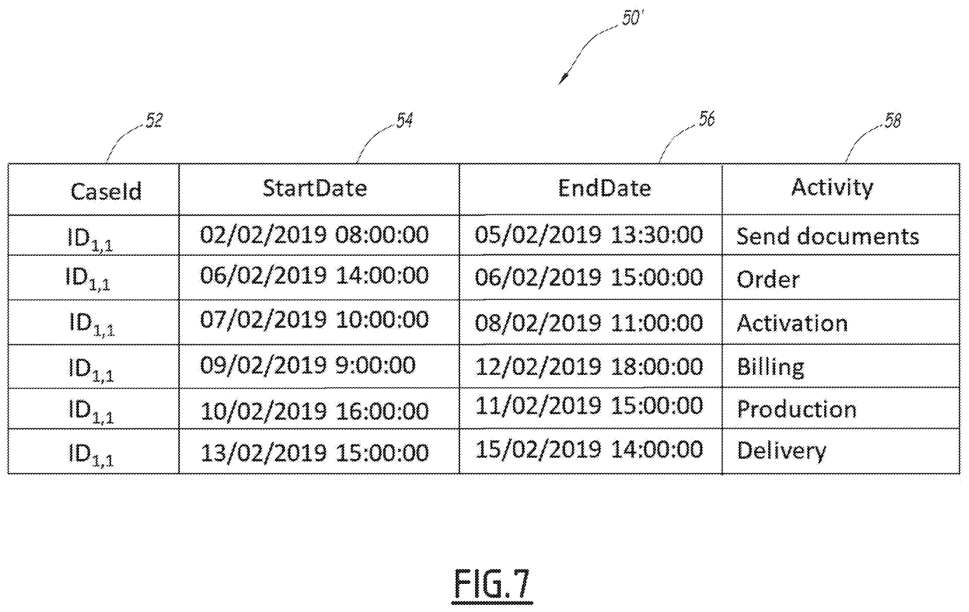

FIGS. 7 to 9 illustrate an example of another instance of a same process as that illustrated in FIGS. 3 to 6.

FIG. 7 illustrates data recovered from computer traces for the instance of the process identified by the process instance identifier ID_{1,1} in table form 50′, similar to table 50 of FIG. 3. Like in the example of FIG. 3, table 50′ lists tasks having a task start date, a task end date and a descriptive label for the executed task. In the example of FIG. 7, it is observed that the “billing” and “production” tasks are concurrent. The “send documents” task in this example is performed before the “order” task.

Of course, the illustrated examples are greatly simplified in order to facilitate understanding. It will be understood that in actual application scenarios, various changes regarding the execution of tasks can occur.

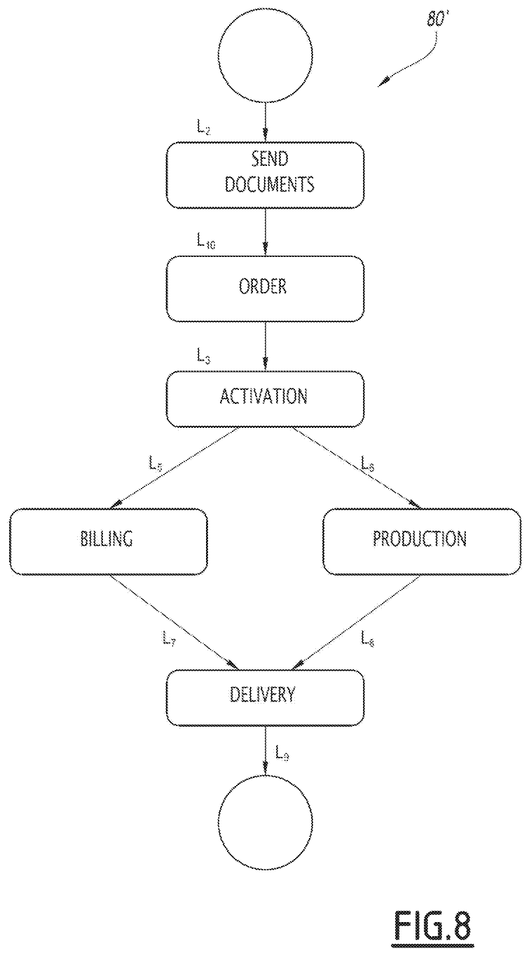

FIG. 8 illustrates a simplified graph 80′ corresponding to the instance of the process with identifier ID_{1,1}, the execution traces of which are shown in FIG. 7. The simplified graph 80′ includes links L₂ to L₉, similar to those of graph 80, as well as a link Lip between the task “Send documents” and the task “Order”, which is new for this instance of the process. In graph 80′, the concurrent links are links L₅ and L₆, links L₇ and L₈.

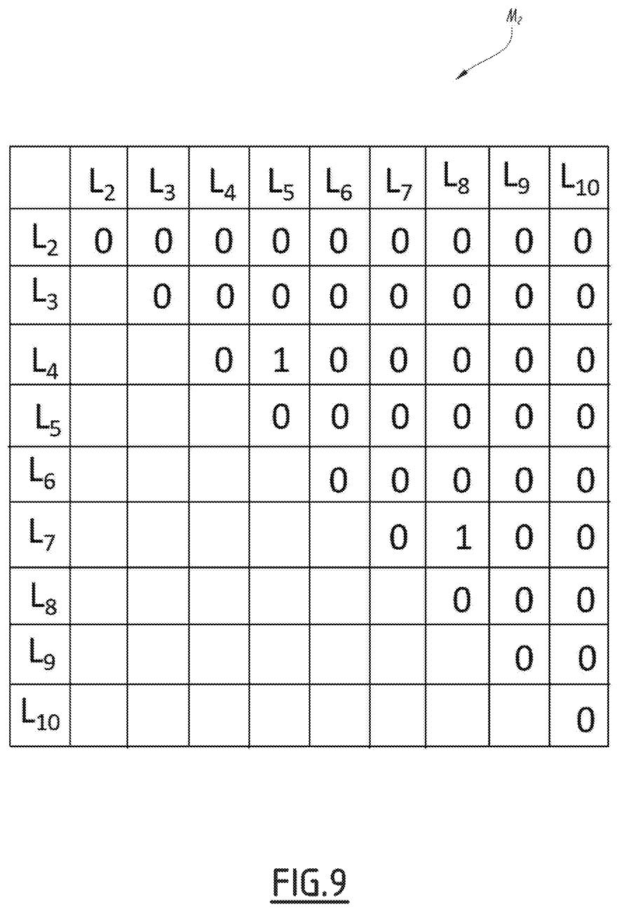

FIG. 9 illustrates a binary matrix M₂ indicating the presence of concurrent links for the instance of the process with identifier ID_{1,1}. In this matrix, a “1” indicates that two links are concurrent, and a “0” indicates the absence of concurrence between two links.

Returning to FIG. 2, step 38 for computing and storing a data structure involving the concurrent links per instance of a process is followed by a step 40 for computing and storing statistics of concurrent links for the process, from data structures previously computed for each instance of the same process.

For example, if the indication of the concurrence of the links is indicated by binary matrices as illustrated in FIGS. 6 and 9, a sum of the matrices is done in computing step 40 in order to obtain a comprehensive matrix including indications relative to the concurrent links.

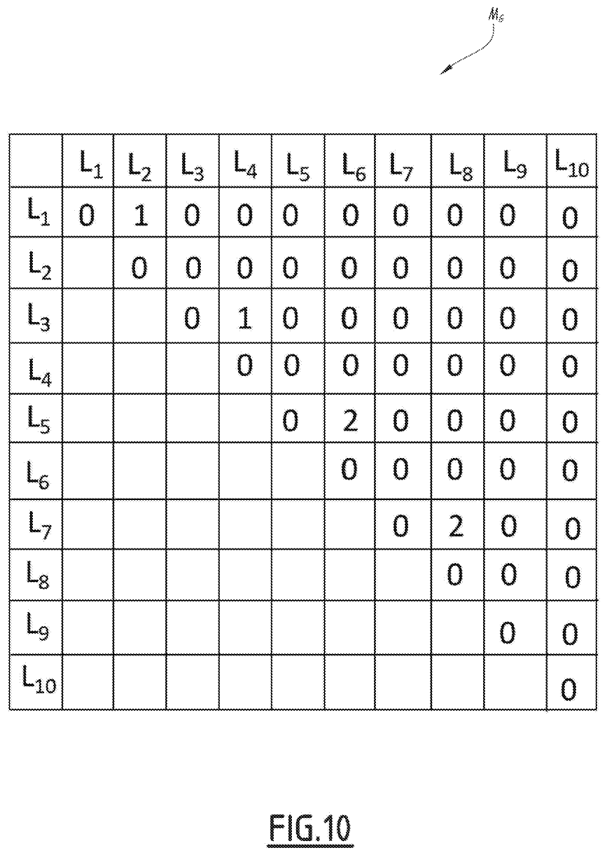

The comprehensive matrix M_{G} obtained from the matrices M₁ and M₂ is shown in FIG. 10.

A concurrence ratio for each link is next computed by dividing the number of concurrences between two links by the total number P of instances of the summed processes.

Lastly, a simplified graph representative of a comprehensive model of the process is computed in step 42, from the determined set of simplified links and the comprehensive matrix computed in step 40.

For each link in this graph, a concurrence ratio with one or several other links of the graph has been calculated.

Lastly, in step 44, the simplified graph computed in step 42 is displayed. The graphic display includes graphic elements able to be selected by the user, their selection making it possible to obtain statistical information on the concurrent links; in particular the concurrence ratio, as well as other information, for example the average duration between the two tasks associated with the link.

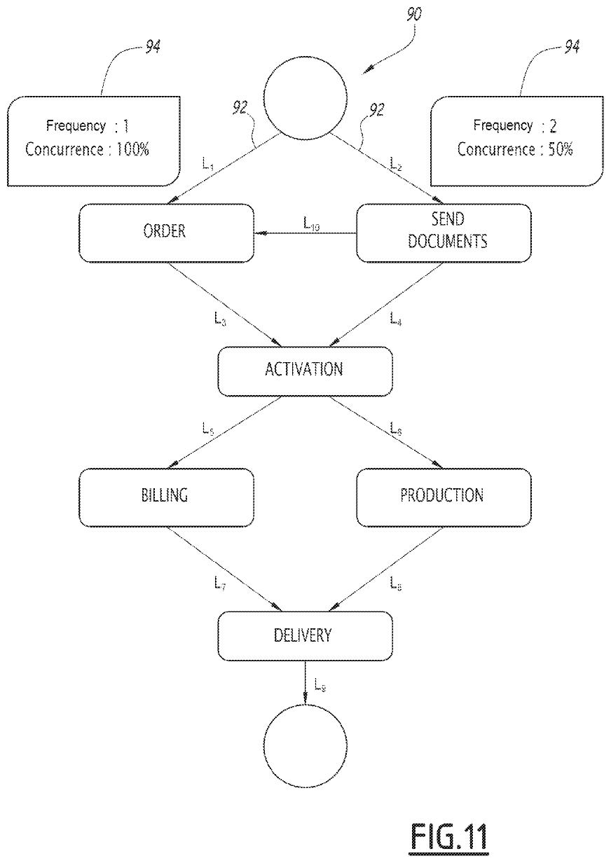

FIG. 11 illustrates simplified graph 90 computed in step 42 and displayed in step 44, in one exemplary embodiment. Graph 90 groups together simplified graphs 80 and 80′, so as to illustrate all of the possible links between the tasks of the process, according to the instances of the process whereof the traces have been processed using the method described above. Graph 90 includes selectable graphic elements 92. Selectable graphic elements 92 are emphasized by a specific display, for example highlighting, a specific color. In the illustrated example, all of the links are emphasized in bold and are selectable graphic elements.

Following a selection by an operator, statistical information is displayed.

For example, an information window 94 is displayed following the selection of a selectable graphic element 92 corresponding to a link.

In the illustrated example, after the selection of the selectable graphic element corresponding to link L₂, the displayed information is the frequency of this link, which is equal to 2, and the concurrence ratio, which is 50%.

In addition, additional statistical information is displayed, for example the average, minimum and maximum duration between the tasks that are connected by the link in question.

Advantageously, the invention makes it possible to effectively compute and display information regarding concurrent links between the concurrent tasks, and to display this information ergonomically for an operator. Thus, the optimization of the processes is greatly facilitated, whether it involves business processes or manufacturing processes.

According to an aspect of the invention, the complete graph representative of a process model from execution instances of the process, resulting from the implementing of first stage 35, and the statistics of concurrent links for the process computed at step 40 are provided as an input to a neural network, and more particularly an Entity Embeddings Neural Network (EENN). The neural network predicts next activities in the form of a graph representative of concurrent activities, next duration of all next activities and estimated end of process.

The EENN efficiently learns the dependencies between the duration of activity at different steps of process and aggregates the activities with similar duration and maturation.

The neural network includes an input layer, at least one hidden layer and an output layer. Advantageously, the output layer predicts a topological context of execution, it is composed of the behavior (concurrency, parallelism) of tasks to be executed next.

In an embodiment, the input includes in particular, for each task, an execution start date and an execution end date, and a descriptive task label, and statistics on concurrent links.

The first target of the neural network is the next tasks encoded labels, the second target of the neural network is the value of the next task duration or the maximal value of the next concurrent/multi-instances tasks duration. A fully connected neural network architecture with embedding layers for categorical features is used in a multi-output learning setting.

The proposed method outperforms other methods for next-task and timestamp prediction, by the capacity to predict all the future next activities and their associated duration therefore greatly improving computing systems for various applications, in particular improving the resource attribution and performance.

1. A method for processing computer system processes implemented by executing sequential or concurrent tasks, execution of the processes by the computer system generating computer traces of execution of the tasks, stored in a memory of the computer system, the processing method being implemented by a computing processor and comprising, for each processed process:
for at least one execution instance of the process,
obtaining, from recorded computer traces, data including, for each executed task, at least a descriptive task label, a beginning of execution date, and an end of execution date;
computing, using the data, a representation model of the executed process, in graphic form including nodes and links between the nodes, the links being representative of a temporal succession between executed tasks;
determining concurrent links associated with concurrent tasks executed at least partially in a same predetermined time interval; and
obtaining and displaying a simplified graph representative of a comprehensive model of the process, from graphs obtained for execution instances of the process, the simplified graph including graphic elements selectable by an operator in order to obtain statistical information on the concurrent links.

2. The method according to claim 1, wherein said computing comprises, for each execution instance of the process, sequencing the performed tasks, based on task start dates, ranked in an increasing order.

3. The method according to claim 1, wherein said computing comprises generating a complete graph, for each execution instance of the process, comprising start nodes, end nodes and intermediate nodes representative of executed tasks and associated with descriptive labels of the executed tasks, the nodes being connected by links.

4. The method according to claim 3, wherein the complete graph further comprises connecting nodes, placed between a node associated with a task having several predecessors and its predecessors, or between a node associated with a task having several successors and its successors.

5. The method according to claim 3, further comprising computing a simplified graph for each execution instance of the process.

6. The method according to claim 1, further comprising, for each execution instance of the process, computing a data structure comprising indications of concurrence between links in the execution instance of the process.

7. The method according to claim 6, further comprising computing statistical information on concurrent links of the process by using the data structures computed for each execution instance of the process.

8. The method according to claim 7, wherein the statistical information comprises a concurrence ratio for each pair of concurrent links computed as a function of the total number of execution instances of the process.

9. The method according to claim 1, wherein the selectable graphic elements are simplified graphic links.

10. A computer program product including software instructions which, when implemented by a programmable device, implement a method according to claim 1 for processing processes.

11. A system for processing computer system processes implemented by executing sequential or concurrent tasks, execution of the processes by the computer system generating computer traces of execution of the tasks, stored in a memory of the computer system, the processing system comprising a computing processor configured to implement, for each processed process:
for at least one execution instance of the process:
a module for obtaining, from recorded computer traces, data including, for each executed task, at least a representative task label, a beginning of execution date, and an end of execution date;
a module for computing, using the data, a representation model of the executed process, in graphic form including nodes and links between the nodes, the links being representative of a temporal succession between executed tasks;
a module for determining concurrent links associated with concurrent tasks executed at least partially in a same predetermined time interval; and
a module for obtaining and displaying a simplified graph representative of a comprehensive model of the process, from graphs obtained for execution instances of the process, the simplified graph including graphic elements selectable by an operator in order to obtain statistical information on the concurrent links.
